(19) United States
(12) Patent Application Publication
(10) Pub. No.: US 2026/0365357 A1
(43) Pub. Date: Nov. 19, 2026

(54) OPTIMIZATION OF MAINTENANCE AND/OR LOADING PLANNING IN A MACHINE LINE

(71) Applicant: Krones AG, Neutraubling (DE)

(72) Inventors: Roland SLADKY, Kirchendemenreuth (DE); Philipp OLENBERG, Regensburg (DE); Martin OBERMEIER, Regensburg (DE); Thomas JATSCHKA, Regensburg (DE); Dominik BUCHFELDER, Weiden (DE)

(21) Appl. No.: 19/676,507

(22) Filed: May 13, 2026

(30) Foreign Application Priority Data
May 14, 2025 (DE) 10 2025 118 533.6

(51) Int. Cl. B65B 57/00; G05B 23/02; G06Q 10/0631

(52) U.S. Cl. CPC B65B 57/00; G05B 23/0294; G06Q 10/0631

(57) ABSTRACT

The disclosure relates to a computer-implemented method and a system for optimizing maintenance and/or loading planning in a machine line, such as for filling and packaging foodstuffs or beverages. Planning data for maintenance and/or loading of the machine line, production planning data, and one or more preferences are input via an input interface. A formal system model describes the functional relationships of data, energy, and/or material flows in the machine line. The formal system model, along with the planning data for maintenance and/or loading, the production planning data, and one or more preferences, is transferred to an artificial intelligence (AI) system. The AI system defines a solution space with a plurality of possible maintenance and/or loading options. The solution space is searched for an optimized maintenance and/or loading plan based on the preferences, and an optimal plan for the maintenance and/or loading of the machine line is output.

### CROSS-REFERENCE TO RELATED APPLICATION

The present application claims priority to German Patent Application No. 10 2025 118 533.6 filed on May 14, 2025. The entire contents of the above-listed application are hereby incorporated by reference for all purposes.

### TECHNICAL FIELD

The disclosure relates to a computer-implemented method and system for optimizing maintenance and/or loading planning in a machine line, in particular in a machine line for filling and packaging foodstuffs or beverages.

### BACKGROUND

In the filling and packaging industry, production plants are becoming increasingly complex, modular machine concepts are widespread, and the demands on efficiency, availability and product quality are constantly increasing. To meet these challenges, plant operators are increasingly relying on software solutions for planning and controlling their production lines. Currently, various software solutions already exist, which are primarily used for the customer-specific planning of individual plant components. These solutions are typically individually tailored to the particular production environment and require comprehensive expert knowledge on the part of the operators of such plants.

### SUMMARY

One problem with this approach is that essential planning processes, such as loading planning and maintenance planning, have so far predominantly been carried out manually and on the basis of the practical knowledge of the planners employed by the operators of the machine lines. In this context, consumable and auxiliary materials such as labels, closures, preforms, lubricants or cleaning agents must be provided in a timely manner and as needed in order to ensure trouble-free operation of the plant. At the same time, maintenance measures must be scheduled in a meaningful manner in order to avoid unnecessary downtimes and maximize the service life of the machines.

The quality of these plannings is strongly dependent on the experience, availability, and qualifications of the personnel. In practice, this often leads to suboptimal results. Unplanned downtimes due to a lack of operating resources, increased reject rates due to inadequate supply or delayed maintenance, and resulting machine damage are not uncommon. These effects have a direct negative impact on overall equipment effectiveness (OEE), product quality, and operating costs.

There are already initial machine-related standalone applications for condition-based supply and maintenance, such as label stock monitoring in labeling machines or fill-level monitoring of preform silos in stretch blow molding machines. Condition monitoring functions for individual machines, such as fillers or labelers, are also used. However, these solutions are selective and isolated. Cross-line functionality based on the comprehensive domain knowledge of the manufacturer and making that knowledge usable as a digital service product in a targeted manner to optimize the overall production line is currently not available.

In particular, there is no unified digital platform that not only monitors the state of individual machines, but also aggregates and interprets this information and derives predictive planning and action recommendations for the loading and maintenance of entire machine lines.

Therefore, there is a need for improved methods and systems for optimizing maintenance and/or loading planning in a machine line.

This object is achieved according to the disclosure by a computer-implemented method as described herein.

One embodiment relates to a computer-implemented method for optimizing maintenance and/or loading planning in a machine line, in particular in a machine line for filling and packaging foodstuffs or beverages. The method comprises providing an input interface. This input interface can, for example, be a graphical user interface having an input mask specially adapted for this purpose. The user can input the following data via said input interface: planning data for maintenance and/or loading of the machine line, production planning data, and one or more preferences. Preferences are boundary conditions defined by a user in the planning for maintenance and/or loading. Then a formal system model for the machine line is captured. The formal system model describes the functional relationships of data, energy, and/or material flows in the machine line. For example, this system model can be derived from the technical development data and simulation data of the plant. The formal system model, along with the planning data for maintenance and/or loading, the production planning data, and one or more preferences, is then transferred to an artificial intelligence (AI) system. The AI system then defines a solution space with a plurality of possible maintenance and/or loading options. For example, all physically possible planning sequences can be contained in the solution space. The solution space is then searched for an optimized maintenance and/or loading plan based on the one or more preferences, and an optimal plan for the maintenance and/or loading of the machine line is output. For example, the output plan can be translated or output into control parameters that are adapted for controlling the machine line. These output control parameters can then be directly implemented in the machine control.

### BRIEF DESCRIPTION OF THE FIGURES

Further embodiments comprise a system for optimizing maintenance and/or loading planning and a corresponding computer-readable storage medium.

Example aspects of the disclosure are shown in the drawings, in which:

FIG. 1: shows an exemplary schematic representation of the system for optimizing maintenance and/or loading planning in a machine line;

FIG. 2: shows an exemplary plant configuration for PET containers and adhesive packaging;

FIG. 3: shows an exemplary plant configuration for PET containers and shrink packers;

FIG. 4: shows an exemplary plant configuration for cans or glass bottles; and

FIG. 5: shows an exemplary plant configuration for cans.

### DETAILED DESCRIPTION

Embodiments of the disclosure relate to various strategies for loading planning and/or maintenance planning, depending on the plant configuration and the preference of a plant operator regarding the plant behavior of the plant or machine line. According to the embodiments, this planning is implemented in the form of an expert system for the overall line, instead of such planning being created manually, as is customary in the prior art. The goal of the expert system is to supplement a production plan with a plan for loading orders and/or a plan for maintenance plans, or to create an optimal production and maintenance and/or loading plan as a whole.

The creation of the production plan is subject to various restrictions derived from the functional relationships of data, energy and material flows, as well as the dependencies on and between operating states, geometries, materials, processes, functions, customer requirements and optimization objectives. Structural functional relationships can be formalized, for example, in the form of product changeover matrices. These restrictions must continue to be observed in the loading planning and maintenance planning. Furthermore, time restrictions must additionally be taken into account for the loading and/or maintenance planning, for example, the period in which loading and/or maintenance must be carried out, as well as dependencies on previous loading or maintenance.

For an operator of such a plant, it can be useful to be shown, by a flexibly usable service and in accordance with customer-specific preferences, the optimization potential in loading planning and/or maintenance planning for the operator's plants/machine lines or for any desired interconnected systems (e.g., logistics systems +BPE plant) for a defined production period (e.g., 1-5 days, 1-4 weeks, 1-2 months, etc.), and to be able to implement this in production. Downtimes can result from product changeover times or dedicated maintenance and loading periods that have been explicitly blocked for production planning. It should be noted that there are not always sufficiently long downtimes in the production plan in which the necessary loading orders or maintenance orders can be scheduled, but these are also necessary during ongoing production. Downtimes can also result from product changeover times or dedicated maintenance periods that have been explicitly blocked for production planning.

Instead of creating the optimization potential for each new plant while taking different preferences into account by explicit programming specific to the customer request, the embodiments described herein make it possible to automatically generate a formal system model of the machine plant, which is derived on the basis of formal product changeover matrices and the auxiliary and consumable materials to be loaded for production of the products (films, cartons, lids, labels, glue, etc.), including their planning-relevant data (transport times, storage locations, available transportable units, and pick-up abilities of the units by transport means and by receiving stations in the machine/plant).

Furthermore, if available, the option of using AGVs (automated guided vehicles) for the automatic loading of various materials can be predefined. For each AGV, its functional scope for loading and the possible hall routes and their restrictions (e.g., one-way operation only, maximum speeds, etc.) are predefined in a formal form.

For maintenance planning and/or loading planning, the formal system model of the machine line can be derived on the basis of the aforementioned restrictions for production and maintenance planning.

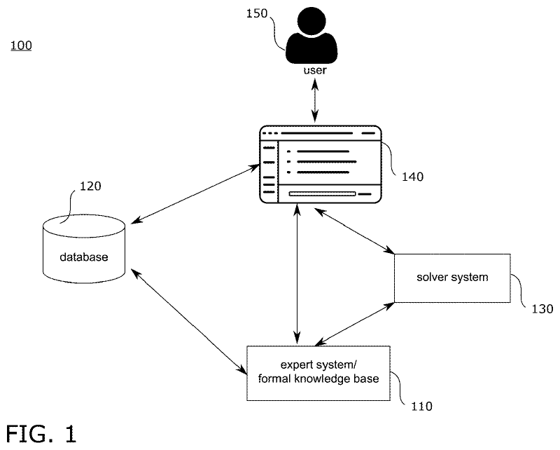

To optimize machine line/machine loading planning or maintenance planning, the formal system model, including current production plans (e.g., from the ERP), current data from loading-relevant and/or maintenance-relevant monitoring systems of the machines/plants to be planned (condition monitoring, prediction systems, etc.), the preferences (e.g., minimum changeover times, maximum OEE, minimum wear, minimal changes to existing production plans, etc.), and the planning specifications (e.g., planning period, partial specifications in the loading plan, and machine-, customer-, or plant-specific scheduling rules, etc.), can be translated into a declarative logic language that can be processed as a query by a knowledge-based AI system (expert system). The expert system possesses its own internal declarative formal-logical knowledge model about the meaning of the query and the transmitted system relationships. To determine the optimal response to the query, the procedure described below can be followed. For illustration purposes, FIG. 1 shows exemplary elements of the underlying system 100.

As a first step, a user 150 can input planning data for loading planning and/or maintenance planning into the system via an input interface 140. The system 100 comprises a computer apparatus that is equipped with special software and hardware. The input interface 140 can, for example, be a graphical user interface. The input interface 140 can comprise a graphical user interface having a query and input mask by which a user is guided, through a query process, to preferences and/or other relevant data.

The user 150 can input planning data for maintenance and/or loading of the machine line, production planning data, and one or more preferences into the system via the input interface 140. According to the embodiments, preferences are boundary conditions defined by a user for planning for maintenance and/or loading. The user 150 can input the data directly via the input interface 140, for example using a keyboard or similar input units. However, the user 150 can also access a database 120 via the input interface 140, in which at least some of the required data is already stored.

For example, to support the input operation, the system 100 can have corresponding interfaces to the production planning system of the user 150 (e.g., ERP/MES system) and to monitoring systems of the plant/machines (including, among other things, information on the existing stock levels of consumable materials in the plant/machines and the anticipated remaining range), which is shown in summary in FIG. 1 as access to the database 120.

After complete input/selection of the relevant data from the production planning system (including the production plan in the loading planning period), the preferences and the planning specifications, a formal system model for the machine line can be captured in a second step. The formal system model describes, for example, the functional relationships of data, energy, and/or material flows in the machine line. The formal system model can be generated, for example, by an AI system, such as the expert system 110, based on data from the database 120. The formal system model, along with the planning data for maintenance and/or loading, the production planning data, and one or more preferences, can then be transferred to the artificial intelligence (AI) system (expert system 110).

The AI system or expert system 110 then defines a solution space with a plurality of possible maintenance and/or loading options. The solution space for all possible actions can be automatically defined taking into account relevant production planning data (e.g., from the ERP), the data from monitoring systems of the plant/machines, the preferences, the planning specifications and an internal declarative formal-logical knowledge model of the expert system 110. In this case, all possible courses of action are grounded by a grounder. A variable-free logic program can be generated as a result. If it is necessary to pass information within the system (for example, to transfer changes or restrictions to other components or machines), this propagation takes place either in parallel in a plurality of system modules, sequentially in a defined order, or directly in the course of grounding, i.e., during the processing and concretization of possible courses of action.

The solution space is subsequently searched for an optimized maintenance and/or loading plan based on the one or more preferences, and a plan for the maintenance and/or loading of the machine line can be output.

The behavior plan output by a solver system 130 can then be translated (back) into a format that can be used for plant/system control. For example, this can be done in the form of control parameters that can be implemented directly by the control system. The plant loading (e.g., via AGV) can likewise be automatically controlled by the output parameters. This can, for example, be an optimal plan with routing for each AGV for loading at the optimal time. Alternatively or additionally, the output plan can provide the plant personnel with the exact loading times in the form of a schedule for each material and pickup and destination locations for the line as a whole.

However, the user 150 can also discard the plan that was output or decline to adopt it, e.g., due to incorrect inputs or new preferences for a new plan. Then this process starts again.

In the event of unplanned occurrences, for example an AGV failure, the system 100 can attempt to perform reactive replanning on the basis of the current execution status of the loading plan and/or the maintenance plan and the unplanned new state in the plant. The last state of the machine line and the loading plan or the maintenance plan can be compared with the previously defined solution space. The planning data can in this case be used, supplemented by the new facts (e.g., AGV failure; one route blocked for 2 hours), as an input in the input interface 140 for an adjustment of the plan.

For the implementation of the system 100, the expert system 110 can be specially adapted to the concrete product design, including necessary standard optimization objectives, standard features, and standard user interface. The formal knowledge base of the expert system 110 is adapted and extended in combination with the AI planning system (e.g., grounder and solver for answer set programming, constraint solver, SMT or SAT solver) to map further formal rules/preferences and performance optimization. The expert system 110 is also extended to include the specifications of the loading dependencies and the maintenance dependencies for the individual machines in the machine line for which automatic planning is offered. Additionally, integration layers can be created in ERP, MES and monitoring systems, for example as APIs, so that the expert system 110 can be integrated into a cloud system. By way of an online connection of the machine line to the expert system 110 in the cloud, or by installation of the expert system 110 at the plant level at the premises of the user 150, optimization of plant loading planning and maintenance planning can be implemented automatically in accordance with the described use case.

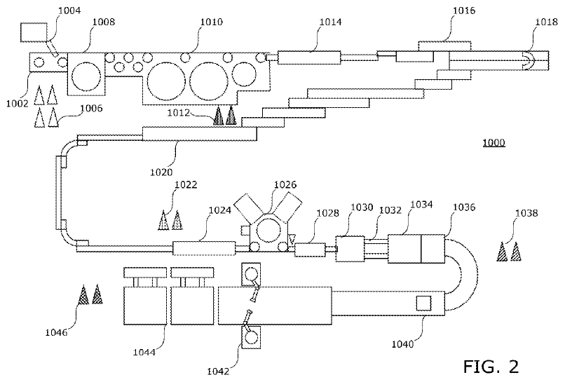

In the following FIG. 2 to 5, various exemplary plant configurations for different bottle filling plants are described in which the disclosure or at least parts and aspects of the disclosure can be implemented. The description of FIG. 2 to 5 is intended only to provide a general overview of machines that can benefit from the monitoring of the embodiments described herein.

FIG. 2 shows an exemplary plant configuration 1000 for PET bottles or PET containers and adhesive packaging. As can be seen in FIG. 2, the plant configuration 1000 comprises a wide variety of modules, which form a line, at the end of which the filled PET containers are output in the form of a pack on pallets. Some of the modules and machines can be optional, and the disclosure is not limited to the exact shape and arrangement of the plant configurations.

The plant configuration 1000 comprises a furnace 1002 for preforms, a preform sorting system with a feeding machine 1004, and a blow-molding machine 1008. Modules 1002, 1004, and 1008 form in general a stretch blow-molding machine in which PET containers are manufactured and formed from a raw material. The produced PET containers are forwarded to a filler 1010 in which the bottles are filled. The filler can optionally comprise a rinser. Various particles such as dust, cardboard, or remains of wooden pallets can collect in the preforms during storage or transport. These can be removed with the rinser. At the end of the filler, a closer can be arranged, using which the PET containers are closed after filling.

Optionally, the plant configuration 1000 can, after the filler 1010, comprise a rotating apparatus, which is used for hot filling of the PET containers. The filled PET containers are guided to a separator 1020 and further to a drying apparatus 1024 in which the PET containers are dried via one or more conveyor belts 1016, which can also comprise a buffer 1018 for intermediate loading of filled containers.

After drying, the PET containers are conveyed to a labeling machine 1026. The labeling machine 1026 can be configured for various labeling techniques such as labeling using hot glue, cold glue, self-adhesive labels, or sleeves. After printing or labeling the PET containers, the PET containers are passed through a second drying apparatus 1028, a line distributor 1030, conveyor belts 1032, adhesive packaging production 1034, and a curing section to a handle applicator. In adhesive packaging production 1034, the PET containers are grouped together in certain group sizes and packaged into a pack such as a “six-pack.” In the handle applicator, a carrying handle is attached to the pack, which allows the pack to be carried comfortably. The finished packs are then accordingly arranged by a robot 1042 for layer production and packed on pallets by a palletizer 1044.

In the plant configuration 1000, so-called format trolleys or format racks can be arranged on various modules and machines in order to provide quickly changeable format sets for short switchover times and automatic tool exchange. Examples of format trolleys are the format trolley 1006 for the blow-molding machine 1008, the format trolley 1012 for the filler 1010, the format trolley 1022 for the labeling machine 1026, the format trolley 1038 for the adhesive packaging production 1034, and the format trolley 1046 for the palletizer 1044.

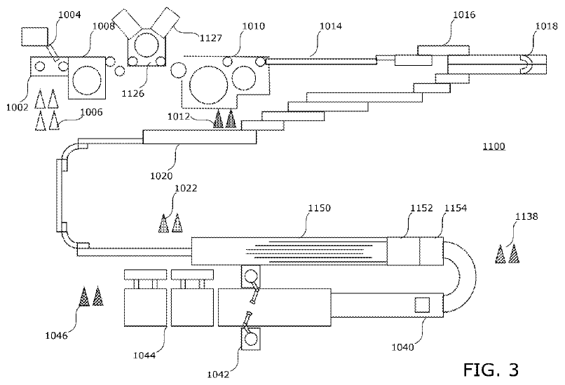

FIG. 3 shows another exemplary plant configuration 1100 for PET containers and shrink packers. The plant 1100 in FIG. 3 comprises many of the modules and machines from the plant configuration 1000 in FIG. 2, but there are some differences. The description of the modules that are already described in connection with FIG. 2 is therefore omitted for FIG. 3.

A key difference between the two exemplary plant configurations 1000 and 1100 is that the labeling machine 1126 with the labeling modules 1127 can already be installed after the blow-molding machine 1008 and before the filler 1008. For this purpose, the plant configuration 1100 can comprise six transport lanes 1150 into which the PET containers can be pushed. After the PET containers have been correspondingly pushed into one of the six lanes 1150, they are conveyed into the film wrapping module 1152 and then into the shrink tunnel 1154.

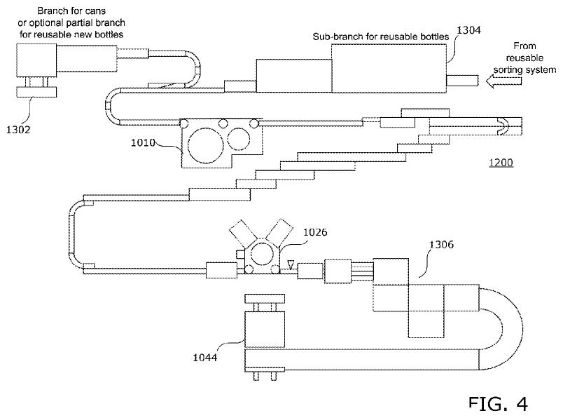

FIG. 4 shows an exemplary plant configuration 1200 for cans or glass bottles. The exemplary plant configuration 1200 from FIG. 4 again has some similarities to the plant configurations 1000 and 1100 from FIGS. 2 and 3, and the description of the plant configuration is therefore limited to the differences between the plant configurations.

As shown in FIG. 4, the exemplary plant configuration can comprise two separate feeds. A first feed, on the left in FIG. 4, shows a branch for cans or, optionally, a partial branch for reusable new bottles. The containers, i.e., cans or new bottles, are fed from a depalletizer 1302 into the machine, where they are guided via conveyor belts to the filler 1010. A second feed, on the right in FIG. 4, shows a partial branch for reusable bottles, which are introduced into the plant from a reusable sorting plant (not shown).

In the case in which the reusable bottles that have already been used are introduced into the plant 1200 via the sub-branch for reusable bottles, the reusable bottles first pass through the cleaning machine or washing machine 1304. Another possible difference of the exemplary plant configuration 1200 is the transfer packer 1306 after the labeling machine 1026. The transfer packer can sort the bottles or cans into a carton clip application or into boxes, or both.

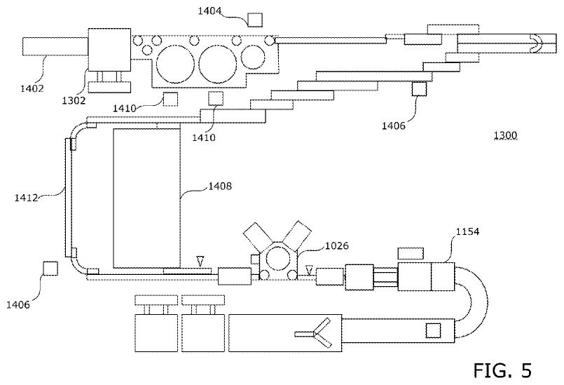

FIG. 5 shows an exemplary plant configuration 1300 for cans, in which configuration the elements already described in the other plant configurations are no longer described. The cans in the plant configuration 1300 are introduced from a magazine 1402 with cans into the depalletizer 1302. The cans, after they have passed through the filler and are filled, are closed by a closure magazine 1404 and are then transported further along the plant 1400 via the conveyor belts as described above.

The optional pasteurizer 1408 can be circumvented via the bypass 1412 if it is not required. In the pasteurizer 1408, the freshly filled products can be pasteurized for preservation.

In contrast to the plant configurations 1000, 1100, and 1200, the exemplary plant configuration 1300 shows various tanks for corresponding consumables, such as the tanks 1410 with rinsing liquid and/or the filling product, and the tanks 1406 with belt lubricant. These tanks can also be contained in the above-described exemplary plant configurations. For example, the chemical products 106 that are fed from the mixer 110 to the machines can be stored in the tanks 1406 and 1410.

1. A computer-implemented method for optimizing maintenance and/or loading planning in a machine line, wherein the method comprises:
providing an input interface for inputting:
planning data for maintenance and/or loading of the machine line,
production planning data, and
one or more preferences, wherein the preferences describe boundary conditions defined by a user in the planning for maintenance and/or loading;
capturing a formal system model for the machine line, wherein the formal system model describes the functional relationships of data, energy, and/or material flows in the machine line;
inputting the formal system model, together with the planning data for maintenance and/or loading, the production planning data and one or more preferences, to an artificial intelligence (AI) system;
defining, by the AI system, a solution space with a plurality of possible maintenance and/or loading options;
searching the solution space for an optimized maintenance and/or loading plan based on the one or more preferences; and
outputting a plan for the maintenance and/or loading of the machine line.

2. The computer-implemented method according to claim 1, wherein defining the solution space comprises:
grounding, by a grounder, all possible courses of action for the maintenance and/or loading of the machine line based on:
relevant production planning data,,
data from monitoring systems of the machine line,
the one or more preferences,
an internal declarative formal-logical knowledge model of an expert system; and
generating a variable-free logic program, wherein searching the solution space for the optimized product sequencing comprises searching the variable-free logic program by a solver.

3. The computer-implemented method according to claim 1, further comprising:
translating the output plan into control parameters that are adapted for controlling the machine line; and
adopting the output control parameters.

4. The computer-implemented method according to claim 1, wherein:
preferences comprise:
minimal changeover times, maximum OEE, minimal reject rate, minimal wear and tear, and/or minimal changes to existing production plans,
planning data for maintenance and/or loading comprises:
a planning period, partial specifications in the maintenance plan, partial specifications in the loading plan, and/or machine-, customer-, and/or plant-specific scheduling rules.

5. The method according to claim 1, wherein the functional relationships and dependencies are formalized in the form of a product changeover matrix.

6. The method according to claim 1, wherein the formal system model is a semantic and formal extension of a digital design model of the machine line and further describes dependencies on and between operating states, geometries, materials, processes, functions, customer requirements and/or optimization objectives.

7. The computer-implemented method according to claim 1, wherein the input interface comprises a graphical user interface having a query and input mask by which a user is guided, through a query process, to preferences and/or other relevant data, wherein the data entered by the user is taken into account by the AI system when defining and searching the solution space.

8. A system for optimizing maintenance and/or loading planning in a machine line, wherein the system comprises:
the machine line;
a computing unit comprising an artificial intelligence (AI) system and an input interface, wherein the computing unit is adapted to:
receive, via the input interface:
planning data for maintenance and/or loading of the machine line,
production planning data, and
one or more preferences, wherein the preferences describe boundary conditions defined by a user in the planning for maintenance and/or loading;
capturing a formal system model for the machine line, wherein the formal system model describes the functional relationships of data, energy, and/or material flows in the machine line;
inputting the formal system model, together with the planning data for maintenance and/or loading, the production planning data and one or more preferences, to the AI system;
defining, by the AI system, a solution space with a plurality of possible maintenance and/or loading options;
searching the solution space for an optimized product sequencing based on the one or more preferences; and
outputting a plan for the maintenance and/or loading of the machine line.

9. The system according to claim 8, wherein defining the solution space by the AI system comprises:
grounding, by a grounder, all possible courses of action for the maintenance and/or loading of the machine line based on:
relevant production planning data,
data from monitoring systems of the machine line,
the one or more preferences,
an internal declarative formal-logical knowledge model of an expert system; and
generating a variable-free logic program, wherein searching the solution space for the optimized product sequencing comprises searching the variable-free logic program by a solver.

10. A computer-readable storage medium having program instructions recorded thereon that, when executed by at least one computer apparatus, configure the at least one computer apparatus for:
providing an input interface for inputting:
planning data for maintenance and/or loading of the machine line,
production planning data, and
one or more preferences, wherein the preferences describe boundary conditions defined by a user in the planning for maintenance and/or loading;
capturing a formal system model for the machine line, wherein the formal system model describes the functional relationships of data, energy, and/or material flows in the machine line;
inputting the formal system model, together with the planning data for maintenance and/or loading, the production planning data and one or more preferences, to an artificial intelligence (AI) system;
defining, by the AI system, a solution space with a plurality of possible maintenance and/or loading options;
searching the solution space for an optimized product sequencing based on the one or more preferences; and
outputting a plan for the maintenance and/or loading of the machine line.

11. The computer-implemented method according to claim 1, wherein the machine line is for filling and packaging foodstuffs or beverages.

12. The computer-implemented method according to claim 2, wherein the production planning data is from an enterprise resource planning (ERP) system.
